(19) United States
(12) Patent Application Publication
(10) Pub. No.: US 2023/0082176 A1
(43) Pub. Date: Mar. 16, 2023

(54) MACHINABLE PREFORM FOR SHAPING INTO DENTAL RESTORATION

(71) Applicant: KURARAY NORITAKE DENTAL INC., Kurashiki-shi (JP)

(72) Inventor: Shinichiro KATO, Aichi (JP)

(73) Assignee: KURARAY NORITAKE DENTAL INC., Kurashiki-shi (JP)

(21) Appl. No.: 17/787,746

(22) PCT Filed: Dec. 22, 2020
(86) PCT No.: PCT/JP2020/048058

§ 371 Date: Jun. 21, 2022

(30) Foreign Application Priority Data
Dec. 23, 2019 (JP) 2019-232125

(51) Int. Cl. A61C 13/00; A61C 13/083

(52) U.S. Cl. CPC A61C 13/0022; A61C 13/083; A61C 13/0003; A61C 5/77

(57) ABSTRACT

A zirconia sintered body for dental use may not require coloring or firing after shaping, and have aesthetic properties. A preform may include a body and a stem. The body has a Vickers hardness of 4 to 20 HV (GPa), and is machinable. The stem has a width of 4 mm or less at a position where it protrudes from a central portion of the body. At this position, the central portion has a cross-sectional geometric shape with an inscribed circle having a diameter of >12 mm, and a circumscribed circle having a diameter of <20 mm. The body shows a color change from an upper to a lower end portion of the body, and unchanging patterns of increase and decrease of the L*a*b* color system values from the upper to the lower end portion. The preform can be shaped into a dental restoration such as a crown.

### TECHNICAL FIELD

The present invention relates to a machinable preform for shaping into a dental restoration.

### BACKGROUND ART

Ceramic materials having known use in dentistry provide high-strength restorations, such as crowns and bridges. Some ceramic materials, when fully sintered, exhibit a flexural strength in excess of 800 MPa, and provide restorations that are resistant against chipping, breakage, and wear. Advances in materials have enabled cost-effective production of restorations from such materials with improved aesthetics in terms of shade and translucency while maintaining the acceptable level of strength.

A dental restoration made by computer-aided design processing may provide a porous restoration design by being milled from a porous ceramic material that is in a green or pre-sinter ceramic stage, using a CAM process, based on the magnification adapted to accommodate an overall size reduction that occurs in heating to full density. After milling, the porous restoration design is sintered to form a final dental restoration. However, the fact that the process involves the two separate steps of milling the porous ceramic dental restoration design (unsintered body or semi-sintered body) and sintering the milled unsintered body into a final dental restoration is a big hurdle for a dentist fabricating a ceramic restoration at the dental office because it can lead to a longer repair time for patients.

In response to this issue, a machinable preform is proposed that can be shaped into a dental restoration having sufficient strength without requiring an additional step of strengthening the dental restoration after shaping (Patent Literature 1).

There is also proposed a zirconia pre-sintered body as a ceramic material that exhibits excellent translucency even after short firing so that the product dental restoration can be obtained at the dental office (Patent Literature 2).

### CITATION LIST

### Patent Literature

Patent Literature 1: JP 2017-77454 T
Patent Literature 2: WO2019/131782

### SUMMARY OF INVENTION

### Technical Problem

However, the present inventor found that the preform disclosed in Patent Literature 1 is monochromatic, and lacks aesthetic properties sufficient to be directly usable in dental applications (particularly as a front tooth), though this patent document discloses coloring the preform body. Patent Literature 2 relates to a zirconia pre-sintered body that is sintered after milling to reduce the firing time, and the pre-sintered body cannot provide sufficient strength comparable to that of a zirconia sintered body without firing. This patent document does not take into consideration situations that do not involve firing. Presumably, this is because of the fact that a zirconia sintered body, in general, is high in strength and hardness, and has a risk of damaging the dental milling machine used at the dental office, and based on the assumption that milling of a large quantity of zirconia sintered body at the dental office is an unlikely situation except for milling performed for fine tuning for finishing.

It is an object of the present invention to provide a zirconia sintered body for processing having the aesthetic properties suitable for dental applications (particularly as a front tooth), without requiring coloring or firing after shaping.

### Solution to Problem

The present invention includes the following.

[1] A machinable preform for shaping into a dental restortion, comprising:

a body constituted of a machinable dental material having a Vickers hardness of 4 to 20 HV (GPa), and that comprises an outer surface, an upper end portion, a lower end portion, and a central portion between the upper end portion and the lower end portion;

a stem having a first stem-end and a second stem-end, the first stem-end having a width of 4 mm or less, and the stem being connected to the body at the first stem-end; and

an optional attaching member connected to the stem at the second stem-end and with which the sintered ceramic preform is attached to a shaping machine while shaping,

the central portion of the body, at a position of the first stem-end, having a cross-sectional geometric shape with an inscribed circle having a diameter of more than 12 mm, and a circumscribed circle having a diameter of less than 20 mm,

the preform showing a color change in a first direction from the upper end portion to the lower end portion,

the preform showing unchanging patterns of increase and decrease of post-sinter (L*, a*, b*) in the L*a*b* color system from the upper end portion to the lower end portion.

[2] The machinable preform for shaping into a dental restortion according to [1], wherein the central portion comprises a cylindrical body, and a circular cross-sectional geometric shape having a diameter of less than 20 mm at the position of the first stem-end.
[3] The machinable preform for shaping into a dental restortion according to [1], wherein the body of the preform further comprises a cavity extending toward the central portion from the lower end surface, and included in the outer surface of the preform body.
[4] The machinable preform for shaping into a dental restortion according to any one of [1] to [3], wherein the machinable dental material comprises a sintered zirconia ceramic material representing zirconia with at least 85 mass % fully sintered zirconia, or representing fully sintered yttria-stabilized zirconia.
[6] The machinable preform for shaping into a dental restortion according to any one of [1] to [4], wherein:

L1 is 68.0 or more and 90.0 or less,

a1 is −3.0 or more and 4.5 or less,

b1 is 0.0 or more and 24.0 or less,

L2 is 60.0 or more and 85.0 or less,

a2 is −2.0 or more and 7.0 or less,

b2 is 4.0 or more and 28.0 or less,

L1>L2,

a1<a2, and

b1<b2,

where (L1, a1, b1) represent post-sinter (L*, a*, b*) of the L*a*b* color system at a first point falling within an interval from one end of the upper end portion to 15% of the entire length on a straight line extending along a first direction from one end of the upper end portion to one end of the lower end portion, and (L2, a2, b2) represent post-sinter (L*, a*, b*) of the L*a*b* color system at a second point falling within an interval from one end of the lower end portion to 15% of the entire length on a straight line extending along the first direction from one end of the upper end portion to one end of the lower end portion.
[6] The machinable preform for shaping into a dental restortion according to any one of [1] to [5], wherein:

L1−L2 is more than 0 and 12.0 or less,

a2−a1 is more than 0 and 6.0 or less, and

b2−b1 is more than 0 and 12.0 or less.

[7] The machinable preform for shaping into a dental restortion according to any one of [1] to [6], wherein:

when an L* value is in a pattern of decrease from the first point to the second point, there exists no interval in which the L* value after sintering increases by 1 or more from the first point to the second point on a straight line connecting the first point and the second point,

when an a* value is in a pattern of increase from the first point to the second point, there exists no interval in which the a* value after sintering decreases by 1 or more from the first point to the second point on a straight line connecting the first point and the second point, and

when a b* value is in a pattern of increase from the first point to the second point, there exists no interval in which the b* value after sintering decreases by 1 or more from the first point to the second point on a straight line connecting the first point and the second point.

[8] The machinable preform for shaping into a dental restortion according to any one of [1] to [7], wherein:

L3 is 66.0 or more and 89.0 or less,

a3 is −2.5 or more and 6.0 or less,

b3 is 1.5 or more and 25.0 or less,

L1>L3>L2,

a1<a3<a2, and

b1<b3<b2,

where (L3, a3, b3) represent post-sinter (L*, a*, b*) of the L*a*b* color system at a third point between the first point and the second point on a straight line connecting the first point to the second point.

[9] The machinable preform for shaping into a dental restortion according to any one of [1] to [8], wherein:

L4 is 62.0 or more and 86.0 or less,

a4 is −2.2 or more and 7.0 or less,

b4 is 3.5 or more and 27.0 or less,

L1>L3>L4>L2,

a1<a3<a4<a2, and

b1<b3<b4<b2,

where (L4, a4, b4) represent post-sinter (L*, a*, b*) of the L*a*b* color system at a fourth point between the third point and the second point on a straight line connecting the first point to the second point.
[10] The machinable preform for shaping into a dental restortion according to any one of [1] to [9], wherein:

the third point is at a distance that is 35% of the entire length from one end of the upper end portion, and

the fourth point is at a distance that is 65% of the entire length from one end of the upper end portion.

### Advantageous Effects of Invention

According to the present invention, a zirconia sintered body for processing can be provided that has the aesthetic properties suitable for dental applications (particularly as a front tooth), without requiring coloring or firing after shaping.

### BRIEF DESCRIPTION OF DRAWINGS

FIG. 1A is a bottom perspective view showing a preform of one embodiment of the present invention.

FIG. 1B is a diagram showing a nested restoration design in an embodiment of a preform in a bottom perspective view.

FIG. 1C is a diagram showing dimensions of a block.

FIG. 2A is a top perspective view of a preform of an embodiment of the present invention.

FIG. 2B is a side view of a preform of an embodiment of the present invention.

FIG. 2C is a front view of a preform of an embodiment of the present invention.

FIG. 3A is a bottom view of a preform attached to a mandrel in an embodiment of the present invention.

FIG. 3B is a top view of a preform attached to a mandrel in an embodiment of the present invention.

FIG. 3C is a side view of a preform attached to a mandrel in an embodiment of the present invention.

FIG. 4 is a perspective view showing a restoration according to an embodiment fabricated from a preform and a preform stem.

FIG. 5A is a bottom perspective view of a preform of an embodiment of the present invention.

FIG. 5B is a side view of a preform of an embodiment of the present invention.

FIG. 6 is a schematic view of a preform of the present invention.

### DESCRIPTION OF EMBODIMENTS

A machinable preform for shaping into a dental restoration of the present invention comprises a body of the preform (hereinafter, also referred to as “preform body”), and a stem. The preform body is a body constituted of a machinable dental material having a Vickers hardness of 4 to 20 HV (GPa), and includes an outer surface, an upper end portion, a lower end portion, and a central portion between the upper end portion and the lower end portion. The stem protrudes from the outer surface of the central portion of the body at a first stem-end having a width of 4 mm or less. In other words, the stem has a first stem-end and a second stem-end, and the first stem-end has a width of 4 mm or less, and the stem is connected to the preform body at the first stem-end. A preform of the present invention may optionally comprise an attaching member connected to the stem at the second stem-end and with which the sintered ceramic preform is attached to a shaping machine while shaping. The central portion of the body, at a position of the first stem-end, has a cross-sectional geometric shape with an inscribed circle having a diameter of more than 12 mm, and a circumscribed circle having a diameter of less than 20 mm. The preform body shows a color change in a first direction from the upper end portion to the lower end portion, and shows unchanging patterns of increase and decrease of post-sinter (L*, a*, b*) in the L*a*b* color system from the upper end portion to the lower end portion.

A preform of the present invention is a sintered body, and differs from a pre-sintered body (semi-sintered body) or unsintered body, which still needs to be fired. In this specification, upper limits and lower limits of ranges of various numeric values (for example, values of various properties) may be combined as appropriate.

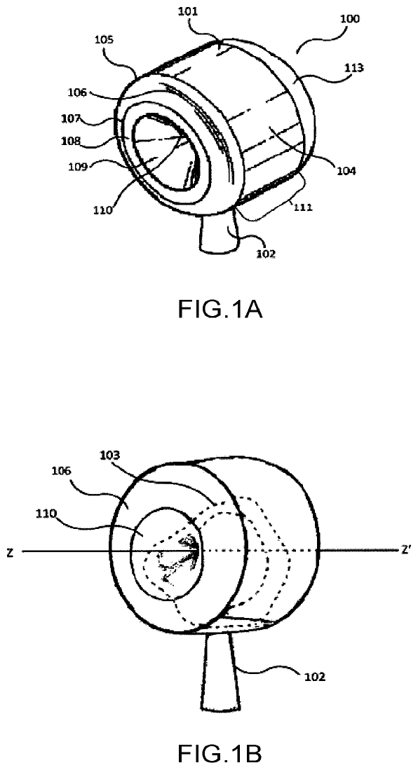

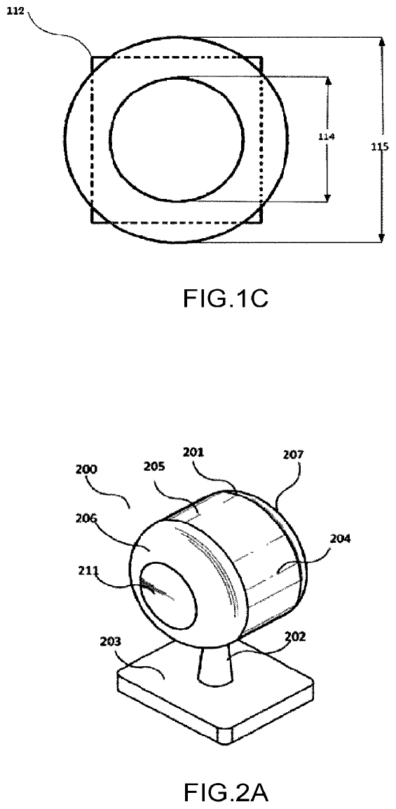

The present specification and the drawings disclose a machinable preform that may be shaped at the dental office into a final dental restoration (such as a crown) that is hard and strong enough as a material to be directly inserted into the mouth of a patient, without requiring sintering after shaping. Referring to the embodiment represented in FIGS. 1A and 1B, the machinable preform (100) includes a preform body (101), and a preform stem (102) protruding from the preform body (101). As illustrated in FIG. 1B, a dental restoration design (103) is selectively nested and positioned with respect to the preform stem (102), and fully rotates (360°) in a model of the preform body. The stem position on a final dental restoration in shaping a restoration from the machinable preform is determined by the nest position.

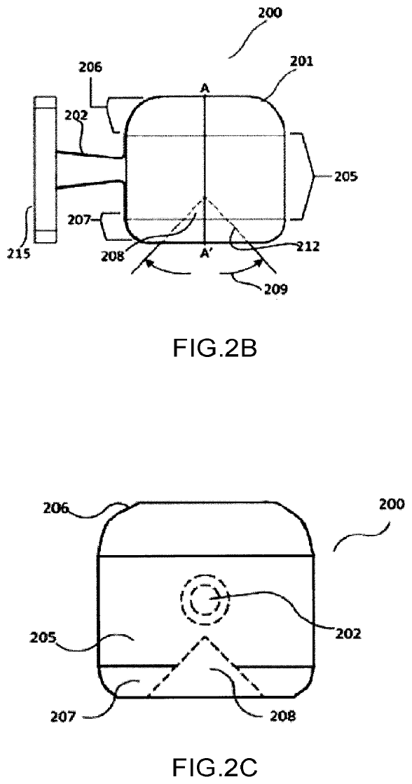

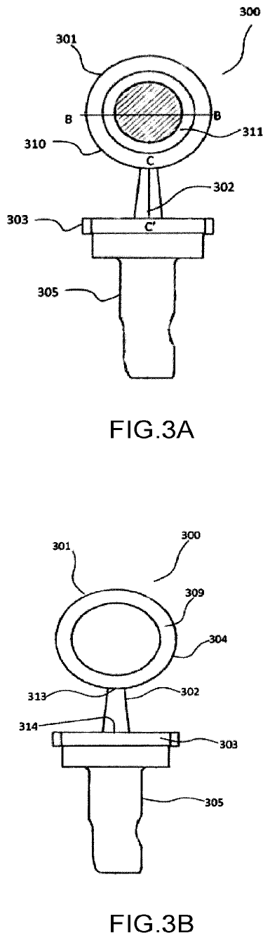

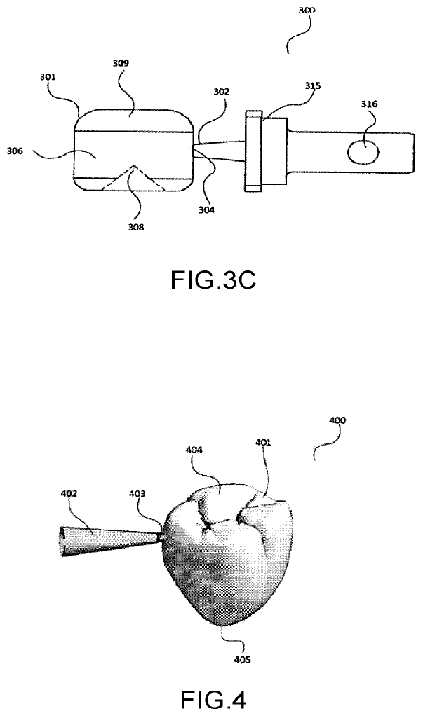

In an embodiment represented in FIGS. 2A, 2B, and 2C, the preform (200) has a circular cylindrical body (201) having a predetermined length (line A-A′) as the length of the cylindrical body (FIG. 2B). The length of the cylindrical body is not particularly limited, as long as the present invention can exhibit its effects. The preform body (201) includes an curved outer surface (204), and a central portion (205) between an upper end portion (206) and a lower end portion (207). In the following, the upper end portion and the lower end portion will also be referred to as “first portion” and “second portion”, respectively. In FIGS. 2A, 2B, and 2C, the length (line A-A′) of the cylindrical body (201) has such an orientation that it is substantially orthogonal to the length (FIG. 3A, line C-C′) of the stem (202). The stem (202) protrudes away from the curved outer surface (204) of the cylindrical body, and extends to an attaching member (203), which is directly or indirectly attached to a shaping machine. The preform body (201) also includes a cavity (208) extending toward the central portion (205) from the cavity breakout dimensions of the lower end portion (207). The curved outer surface (204) of the central portion (205) of the cylindrical body illustrated in FIGS. 2A, 2B, and 2C is substantially smooth, and the central portion (205) has substantially a uniform external form between the upper end portion and the lower end portion.

FIGS. 3A, 3B, and 3C represent an embodiment of a preform (300). The cylindrical preform body (301) includes a circular upper end surface (309) and a circular lower end surface (310), a central portion (306) having substantially a circular cross section with an external form (line B-B), and a depression (311) where a cavity (308) extends inwardly toward the central portion (306). The stem (302) extends away from the curved preform-body outer surface (304) of the central portion between the upper end portion and the lower end portion, at a position substantially equidistant to the upper end portion and the lower end portion. The stem extends between the curved central portion (306) and the attaching member (303). The attaching member (303) joins a mandrel (305) at its base (315), indirectly attaching the preform to a shaping machine.

A preform body shaped (formed and milled) into a crown restoration may have a central portion having a cylindrical form such as that shown in the drawings. However, other shapes may be suited for use in the present invention. Alternatively, the body (101) or the central portion of the body includes shapes, for example, such as an elliptic cylinder, a polyhedron, a curved polyhedron, a cylinder with flat faces, a cube, and a cube with round sides. FIG. 1B represents an embodiment in which the shape and size of preform body (101) accommodates to a full rotation of the restoration design (103) in the preform body about the z axis (line Z-Z′), and, accordingly, the preform includes a stem (102) layout through 360° (full rotation) relative to a final dental restoration. The outer diameter of a circular cross section of the central portion from which the restoration design is shaped may be about 12 mm to about 20 mm, about 13 mm to about 18 mm, or about 14 mm to about 17 mm. The preform body length between the upper end portion and the lower end portion is long enough to accommodate the heights of most final dental restorations (400), for example, when the restoration is measured from the highest point (404) of the occlusal surface to the lowest point (405) of the tooth margin. Accordingly, the preform body, or the central portion of the preform body, may have a length that is less than 20 mm, less than 18 mm, less than 16 mm, or less than 15 mm, or about 10 mm to 15 mm. In some embodiments, the ratio of the diameter across the central portion and the length of the preform body is greater than 1.0:1.0.

In some embodiments, a preform body having a non-circular cross section or an irregular cross section has a cross-sectional geometric shape in the central portion for a full rotation (360°) of a restoration design about the z axis. A preform body having an upper portion, a lower portion, and a central portion between these portions has a cross-sectional geometric shape (substantially parallel to the surface of the upper portion and the surface of the lower portion) with an inscribed circle having a diameter of more than about 12 mm, and a circumscribed circle having a diameter of less than about 20 mm at the position where the stem protrudes from the central portion. The central portion may comprise a cylindrical body, and a circular cross-sectional geometric shape having a diameter of less than 20 mm at the first stem-end position. In contrast, a typical example of a block having the size and shape (for example, about 15 mm×16 mm) of a known mill block has the cross-sectional geometric shape (112) shown in FIG. 1C. In this example, the inscribed circle (114) of a selected diameter (for example, 12 mm) is confined in the cross sectional dimensions of a typical block. However, the cross-sectional geometric shape of a typical block cannot be confined in the circumscribed circle (115) of a selected diameter (for example, 20 mm). This results in a reduction in the size of a crown restoration design that can be fully rotated within a known block design without increasing the block size.

In some embodiments, the preform body has flat end surfaces, and a cross sectional diameter or width that is uniform throughout the length of the body. Alternatively, the preform has tapered upper-end and lower-end regions (206, 207), and has an upper end surface and a lower end surface that are smaller in diameter or width than the central portion (205). The tapered upper end and/or lower end portions may have a shaped edge between the preform outer surface (204) of the central portion and the end surface (for example, lower end surface 211), or a shaped edge around the cavity (208) at the end surface, or may have both of these shaped edges. For example, as shown in FIG. 1A, the lower end region (105) has a first filleted edge (106) between the outer surface (104) of the central portion and the lower end surface (107), and, with the second filleted edge (108) surrounding the depression (109) at the lower end surface (107), the cavity (110) extends inwardly toward the central portion (111) of the cylindrical body from the second filleted edge. In the embodiment represented in FIG. 1A, the preform body is tapered toward the upper end region (113) having a filleted edge between the upper end surface (not shown) and the preform body outer surface (104).

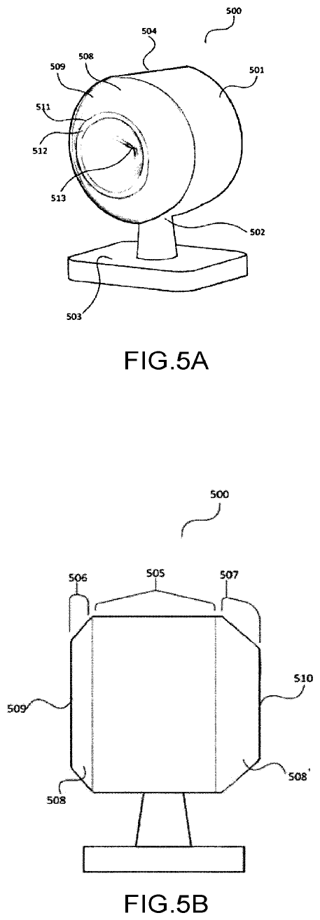

Another preform (500) is illustrated in FIG. 5A (bottom view) and FIG. 5B (side view). FIGS. 5A and 5B show a preform body (501) having a stem (502) and an attaching member (503). The preform body (501) has a lower end region (506) and an upper end region (507) both having a chamfered edge (508, 508′). The diameter of the preform body outer surface (504) is tapered toward the upper end surface and lower end surface (510 and 509, respectively) from the central portion (505). The lower end region (506) illustrated in FIG. 5A has a second chamfered edge (511) forming a depression (512) in the lower end surface (509), and the cavity (513) extends toward the central portion from the depression.

In some embodiments, the machinable preform having one or more shaped edges has less material to be removed in the fabrication of a final dental restoration such as a crown. The shaped edge around the cavity may provide easy access to the cavity for shaping tools. Because the preform material is essentially absent in the cavity, the amount of material that needs to be removed in shaping a restoration can be reduced. As illustrated in FIG. 5A, the cavity (513) extends into the central portion of the preform body from the cavity opening, and forms an inner surface from the depression in the upper end surface and/or lower end surface. In other embodiments, the cavity is formed at the front and back ends of the preform.

The cavities may have the same or different shapes, and may include a shape such as an inverted circular cone, a dome, a cylinder, or a groove. However, the shape is not limited to these, and the cavity may have an irregular shape. The opening or breakout geometry of the cavity may have a width (or a diameter when the breakout area is circular, for example) that is about 20% to 80% of the outer diameter or width of the central portion of the preform body. As used herein, the term “width” may refer to diameter when the object of interest is circular. In some embodiments, the opening of the cavity has a width that is about 30% to about 75%, or about 40% to about 75% of the outside width of the central portion of the preform body, or a width that is 50% to 80% of the outside width of the central portion. Alternatively, the cavity opening or breakout dimensions have a surface area that is about 50% to about 80% of the surface area of the upper end surface or lower end surface, or the surface area of a cross section of the central portion.

The cavity may have a depth that is approximately 5% to 50%, 10% to 35%, or 10% to 30% of the length of the preform body of when the preform is measured from upper end to lower end. The circular cavity opening may have an inside diameter that is at most about 75% of the outer surface diameter of the preform body as measured from the end surface.

In some embodiments, the preform body has an inner surface (212) formed by the cavity, and that has a shape close to an inverted circular cone. The inner surface is accessed by a machining tool, and is machined into a concave surface of a dental restoration where the restoration joins and contacts a structure in the mouth of a patient. Less material needs to be removed during the shaping process by nesting a restoration design in a model of the preform body, and coaxially aligning the cavity of the preform with the recessed inner surface of the restoration design.

In one embodiment, the preform body has a cross sectional width (may refer to diameter, as noted above), and a length that accommodates at least about 90% of the size of all of single anterior and posterior dental restorations (for example, first and second molars and premolars), in order to eliminate the need for dentists to secure inventory of preforms of different sizes and shapes. The preform body may be designed based on information of previously prepared restoration designs of different shapes and sizes. In one embodiment, the preform body is designed as an electronic representation of several thousands of single crown restoration designs obtained and overlaid in such a manner that the raised inner surface of the restoration design is oriented around a common axis (for example, the axis shown in FIG. 1B). In one embodiment, the preform body design is a combination of restoration designs of more than one type of anterior teeth (for example, central incisor, lateral incisor, canine, and, optionally, first and second premolars). In another embodiment, the preform body design is a combination of restoration designs of more than one type of posterior teeth (for example, first and second molars, and, optionally, first and second premolars). In yet another embodiment, the preform body design is a combination of restoration designs of anterior and posterior teeth.

The overlaid and coaxially aligned restoration design is rotated about the common axis. During rotation, the maximum dimensions of the composite design (for example, the split line or silhouette of the restoration design) form maximum outer surface dimensions of the shaped body design. In some embodiments, the outer surface of the shaped body design is smoothed based on the maximum outer surface dimensions to form substantially a cylindrical shape and a circular cross section that rotates 360° about the central axis (for example, line Z-Z′) and having a diameter of a size suited to nest about 90% of the restoration design. The preform edge between the lower end portion and the upper end portion, and the central portion may be shaped as above. Optionally, the preform cavity design corresponds to a recessed surface of a composite restoration design smoothed to provide the inner surface of an inverted circular cone shape to a preform body.

In one embodiment, a preform body is provided that has a rounded or circular cross section design accommodating similarly sized composite restoration designs and having less material volume than a normal cubic or rectangular prism-shaped preform block having about a 90° angle at the edges or corners. A single preform design that accommodates a full rotation of a composite restoration design about the z axis contrasts with a block of a near net shape having an asymmetrical geometric shape imitating or mimicking an asymmetrical tooth shape. A tooth-shaped block of a near net shape does not accommodate a rotation of a restoration design, and requires a large library or a kit of specific tooth types or tooth numbers, in order to secure a range of potential equipment for different types and sizes of restorations.

The stem provides support to the preform body while the preform body is being shaped into a final dental restoration. The stem may have a length that provides a sufficiently large space between the preform body and the attaching member to allow a grinding tool to be disposed at a position adjacent the preform body in the path of the tool, without contacting the preform material. In the embodiment illustrated in FIGS. 3A and 3B, the stem (302) bridges between the cylindrical body (301) and the attaching member (303), and extends from the outer surface of the cylindrical body substantially orthogonal to substantially the middle between the upper end portion and the lower end portion. The stem may protrude from the outer surface of the preform at a position equidistant to the upper end surface and the lower end surface, or within about 15% to about 25% of the middle between the upper end surface and the lower end surface. In other embodiments, the distance from the stem junction to the upper end portion or lower end portion may be equal to a distance equal to about 20% to about 80%, about 25% to about 75%, or about 30% to 70% of the length of the preform body, or may be equal to a distance equal to about 40% to 60% of the length of the preform body.

The axis (line C-C′) of the stem length may be substantially orthogonal to the axis (line A-A′) of the length of the cylindrical body (301). In some embodiments, the axis of the stem length is within about 30° or about 45° of orthogonal to the preform body length. The stem may have a shape of, for example, a cylinder, a circular cone, or a pyramid. In one embodiment, a preform body that is tapered toward the shaped edges at the front and lower ends has a stem extending from the central portion of the preform body, and, after machining, connecting to the center of the final dental restoration (400), away from the occlusal surface and the edge, or the tooth margin, as shown in FIG. 4.

In one embodiment, the preform body is a fully sintered material, and, from sintering to machining, the flexural strength of the stem (302) at the first stem-end (313) is high enough to support the sintered preform (300), and is low enough to break off the final dental restoration from the stem with ease, for example, with hands. The stem (302) of the preform (300) remains attached to the sintered cylindrical body (301) at the first stem-end (313), and supports the cylindrical body (301) throughout the shaping process, until the final dental restoration is obtained. In contrast to the preform body described in the present specification having the stem (302) extending from the outer surface of the shapeable preform body, the conventional restoration milling process produces sprues or connectors, which are remnants of unsintered block material, in the shaping process.

In some embodiments, the length of the preform stem before shaping into a restoration is longer than the stem width at the first stem-end (313) adjacent the preform body. The stem length may be about 3 mm to about 12 mm, or about 3 mm to 10 mm. In some embodiments, the stem length may be more than about 3 mm, more than about 4 mm, more than about 5 mm, more than about 6 mm, or more than about 8 mm. In one embodiment, the width at the first stem-end adjacent the cylindrical body (in the present specification, the term “width” is also used to refer to stem diameter) is less than the width (diameter) of the second stem-end (314) adjacent the attaching member (303). The first stem-end width may range from 1 mm to 5 mm, about 1 mm to about 4 mm, about 1.5 mm to about 3.5 mm, or 1.5 mm to about 3 mm, or may be about 4 mm or less, about 3 mm or less, about 2.5 mm or less, or about 2 mm or less.

In some embodiments, the ratio of the stem length to the width at the first stem-end (the end adjacent the cylindrical body) is 1.5:1 or greater, more than 2:1, more than 3:1, or more than 3.5:1, and less than 6:1, less than 5:1, less than 4.5:1, or about 4:1 or less. In one embodiment, the stem has a length long enough to provide access and a location for a machining tool between the attaching member and the cylindrical body without making the machining tool contact the preform material, and to thereby reduce wear on the machining tool when machining the cylindrical body near the stem. Accordingly, in such an embodiment, the stem length is longer than the diameter of the tool tip or shank, or both.

The attaching member (303) is joined to the stem at the second stem-end (314), and secures the machinable preform to the shaping machine, either directly or indirectly via an intermediate component (e.g., mandrel 305) during the shaping process. The shape and size of the attaching member may be compatible to any machine or intermediate mandrel suited for shaping the sintered preform into a final dental restoration. The attaching member may directly or indirectly secure the sintered preform to the machine by a mechanical means including a clamp, a grip, an adhesive, or other mechanical attachments. For example, an attaching member shaped into a square, rectangular, or circular form and having substantially a flat bottom surface (315) may be attached to a mandrel with an adhesive, as shown in FIG. 3A. In another embodiment (not illustrated), the sintered preform includes an attaching member that can be inserted and attached to a mandrel, and is secured by engaging or clamping the attaching member in the mandrel. In an example of such an embodiment, the stem is elongated, and is shaped to insert the second stem-end into the mandrel. The attaching member may have a hole (316) for placement of a screw, or a mechanical means of attachment to the mandrel, or directly to a shaping machine, such as a dovetail.

The preform material may contain a material having a Vickers hardness value of about 4 HV (GPa) (a macro Vickers hardness) or greater, or 4 to 20 HV (GPa), when measured according to the method provided in the present specification. Alternatively, the preform material has a Vickers hardness value of 5 to 15 HV (GPa), or 11 to 14 HV (GPa). The preform body material having these ranges of hardness values may contain metals such as cobalt-chrome, glass and glass-ceramics such as lithium silicate and lithium disilicate, and ceramics that contain sintered ceramics containing alumina and zirconia. Dental restorative materials containing commercially available dental glasses, glass-ceramics or ceramics, or a combination of these but that are not limited to these may be used to fabricate the machinable preform described in the present specification. The ceramic material may contain zirconia, alumina, yttria, hafnium oxide, tantalum oxide, titanium oxide, niobium oxide, and a mixture of these. The zirconia ceramic material includes a material of primarily zirconia containing about 85 mass % to about 100 mass % of zirconia with respect to the ceramic material. The zirconia ceramics may contain zirconia, stabilized zirconia (such as tetragonal stabilized zirconia), and a mixture of these. The yttria-stabilized zirconia may contain about 3 mol % to about 6 mol % yttria-stabilized zirconia, or about 2 mol % to about 7 mol % yttria-stabilized zirconia. The yttria content means a proportion of yttria (mol %) with respect to the total number of moles of zirconia and yttria. Non-limiting examples of stabilized zirconia suited for use in the present specification include commercially available yttria-stabilized zirconia (for example, the TZ-3Y grade available from Tosoh Corporation). The method of fabrication of dental ceramics suited for use in the present specification can be found in U.S. Pat. No. 8,298,329, the entire content of which is incorporated herein by reference.

The unsintered material has substantially the same geometric shape as the sintered preform. However, the unsintered material may optionally be shaped into an intermediate form having increased dimensions to accommodate the shrinkage that occurs during sintering. The intermediate shaped form may be fabricated by injection molding, milling, or grinding the unsintered material. Examples of suitable unsintered ceramic materials include ceramic powders and ceramic blocks that have not been fully sintered to the theoretical highest density. The ceramic powder may be fabricated in a block form by a process including molding and biaxial or isostatic pressing, and may optionally contain a binder and a process auxiliary agent. Optionally, the ceramic powder may be processed into a block form by a slip casting process, including the processes described in US Patent Application Publication Numbers 2009/0115084, 2013/0231239, and 2013/0313738, the entire content of which is incorporated herein by reference.

A coloring material may be used to fabricate a colored machinable preform having the color of natural or artificial teeth not requiring further coloring after the formation of a dental restoration. A colorant may be incorporated during powder or block formation, in order to provide an appearance even closer to natural teeth or commercially available artificial teeth, compared to uncolored or colorless ceramic materials. For example, a method of coloring a ceramic with a colloidal dispersion, and casting the ceramic by slip casting is described in US Patent Application Publication Number 2013/0231239, the entire content of which is incorporated herein by reference. As another example, a method of fabrication of a colored ceramic powder formed into a green-state ceramic body by an isostatic or biaxial press manufacturing process is taught in US Patent Application Publication Number 2014/0109797, the entire content of which is incorporated herein by reference. Optionally, the colorant may be directly mixed with, for example, a metal salt, a coloring liquid, or a ceramic powder (a colored powder) before being pressed into a block form. Optionally, an intermediate preform shape fabricated from a porous material may be colored, for example, by being immersed in a coloring liquid, and sintered.

In order to more easily enable shaping by reducing porosity and preventing chipping or breakage, the unsintered material includes a green-state pre-sinter ceramic block, which may be heated or partially sintered, fabricated by the foregoing process. The pre-sinter block is hard enough to maintain the structure needed for milling into a shaped form, but is soft enough to enable quick shaping without damaging the milling tool. The pre-sinter block is not heated or sintered to full density. Examples of a pre-sinter block useful in the method described in the present specification include a porous block that may have a density about 50% to about 90%, or 50% to 95% of the theoretical highest density of a fully sintered ceramic material. It is to be noted that the pre-sinter density may include a non-ceramic binder and ceramic particles, compared to the theoretical nonporous density of a fully sintered ceramic block. In some embodiments, the theoretical highest density of a fully sintered zirconia ceramic is about 5.9 g/cm³ to about 6.1 g/cm³, or, for example, about 6.08 g/cm³. Examples of a pre-sinter block suited for use in the fabrication of an intermediate shaped form include commercially available ceramic mill blocks, including the KATANA® zirconia block manufactured by Kuraray Noritake Dental Inc.

Shrinkage, which occurs during sintering because of the porosity of the pre-sinter ceramic block, can be calculated from the density of a material having highly predictable shrinkage. Accordingly, the intermediate shaped form may be larger than the final preform by an amount of a scale factor predicting a size reduction that occurs during sintering to full density. Similarly, an intermediate shaped form fabricated by injection molding of an unsintered ceramic material that shrinks during sintering is designed by taking into account the expansion factor predicting a size reduction that occurs during sintering. An intermediate shaped form may be designed, and milling instructions corresponding to milling using a scale expansion factor may be sent using a CAD/CAM process. The intermediate shaped form can be milled with commercially available mills and milling tools, for example, such as those designated by the maker according to the requirements of ceramic mill blocks.

A one-unit or monolithic preform including the preform body, the stem, and, optionally, the attaching member is shaped from a single continuous green-state block or a pre-sinter ceramic block, and does not require a separate step of attaching the stem and/or attaching member to the preform body. Alternatively, the stem and attaching member may be fabricated as a one-unit structure, and may be attached to the preform body in a separate step. In another embodiment, a shaped preform is fabricated by a known molding process, including injection molding, and forms a one-unit or monolithic preform having the preform body, the stem, and, optionally, the attaching member as a continuous structure. Alternatively, the shaped form may be fabricated by a combination of molding and milling techniques, for example, by first forming an intermediate shaped form, and then milling the stem and/or attaching member using a standard milling technique. Alternatively, the stem and the attaching member may be separately attached to the preform body before or after sintering.

The intermediate shaped form may be sintered to a density higher than about 95% of the theoretical highest density, using a known sintering protocol. A material production protocol suited for sintering of a dental restoration may be used when a ceramic preform such as a zirconia ceramic preform is sintered to a density higher than about 95%, higher than about 98%, higher than about 99%, or higher than about 99.5% of the theoretical highest density of the ceramic body. For example, an intermediate shaped form milled from a pre-sinter zirconia block may be sintered at about 400° C. to 1,700° C. for about 30 minutes to 48 hours, or may be sintered according to the sintering protocol provided by a ceramic block maker to form a sintered zirconia preform having a density of about 5.8 g/cm³ to 6.1 g/cm³ (for example, 6.08 g/cm³), or about 5.9 g/cm³ to 6.0 g/cm³.

The preform body contains a material that may be shaped as a dental restoration, and that has the strength characteristics sufficient to allow use in anterior or posterior dental restoration applications, or in both anterior and posterior dental restoration applications, and the preform body does not involve a post-shaping processing step of changing the material strength characteristics by a process such as sintering after shaping. The sintered preform may contain a zirconia ceramic material having a high flexural strength of higher than about 400 MPa, higher than about 500 MPa, higher than about 600 MPa, or higher than about 800 MPa, when tested according to the flexural strength test method for zirconia materials reviewed in ISO 6872:2008 by conducting measurements and calculations according to the three-point flexural strength test described in Density-Ceramic Materials.

A method of fabrication of a machinable preform used for dental restorations is disclosed that includes the steps of:
a) obtaining an unsintered zirconia ceramic material;
b) shaping the unsintered zirconia ceramic material into an unsintered shaped form that includes a cylindrical body of unsintered ceramic material having an upper end portion, a lower end portion, and a central portion between the upper end portion and the lower end portion, a cavity present in at least one of the upper end portion and the lower end portion, and a stem protruding from the outer surface of the central portion of the cylindrical body; and
c) sintering the unsintered zirconia ceramic shaped form to achieve a density about 98% to about 100% of the theoretical highest density of the zirconia ceramic body, and form a machinable sintered preform.

In one embodiment of the method, the unsintered zirconia ceramic material is a single pre-sinter ceramic block, and the step of shaping the unsintered ceramic shaped form includes milling the zirconia pre-sinter ceramic block into a monolithic shaped form having the body portion and the stem as a continuous structure. In another embodiment, the step of shaping the unsintered ceramic form includes shaping the unsintered ceramic material into a monolithic shaped form. In one embodiment, the pre-sinter zirconia ceramic shaped form has a cylindrical body and a stem having a first size, and is sintered to form a fully sintered zirconia preform (also referred to as “sintered zirconia preform” or “zirconia sintered body”) having a cylindrical form and a stem of a reduced, second size.

The fully sintered zirconia preform is shaped into a final dental restoration based on CAD design, using a CNC machine and grinding tools. FIG. 4 illustrates the final dental restoration (400) fabricated from the sintered preform. The crown restoration (401) shaped from the sintered preform is shown in a state before removal of the stem (402) extending from the crown outer surface between the tooth margin and the occlusal (masticatory) surface. In some embodiments, the sintered preform material (403) remains in minimum amounts in the cylindrical body between the final dental crown restoration (401) and the stem (402), and may be removed, for example, by hand sanding, when removing the stem. In one embodiment, a single grinding tool may be used to shape the fully sintered zirconia preform into a final dental restoration, over a time period of less than about 60 minutes.

A kit is provided that comprises a grinding tool and a machinable preform, and that is for forming a dental restoration having the strength and hardness value suited for use as a posterior dental crown restoration, without requiring a post-shaping process for the preform material to adjust the strength characteristics of the dental restoration shaped from the preform material. The machinable preform includes a preform body, and a stem extending substantially orthogonal to the preform body length. A single grinding tool may be used to shape the preform body into a final dental restoration, and the grinding tool has a diamond-coated shank including a diamond, 107 microns to 250 microns in size on average, embedded in an alloy layer having a thickness about 60% to 95% of the height of the diamond. In one embodiment, the preform body contains, for example, a previously colored material that has been selected to match an existing color of dentition or a shade guide, and that does not require coloring or sintering after shaping.

In further embodiments, a plurality of similarly shaped preform bodies is provided in a plurality of colors suited for use in fabrication of dental restorations that do not require coloring or sintering after shaping, within a range of dental shades such as shades corresponding to the colors of the Noritake Shade Guide, the VITA Classical Shade Guide, or other commercially accepted shade guides suited for use in dental industry.

It is important that a preform of the present invention show a color change in a first direction from the upper end portion to the lower end portion, and show unchanging patterns of increase and decrease of post-sinter (L*, a*, b*) in the L*a*b* color system from the upper end portion to the lower end portion. Patent Literature 1 suggests coloring, however, the preform obtained is monochromatic, and does not have a shade with gradually changing colors. Patent Literature 1 suggests a coloring method, such as mixing a coloring liquid and a ceramic powder into a slurry. However, the method produces a monochromatic slurry, and cannot produce a slurry having more than one color. A preform having more than one color cannot be obtained even by immersion in a coloring liquid because the coloring liquid is monochromatic.

In view of reproducing the shade suited for dental use, it is preferable in a preform of the present invention that:

L1 is 68.0 or more and 90.0 or less,

a1 is −3.0 or more and 4.5 or less,

b1 is 0.0 or more and 24.0 or less,

L2 is 60.0 or more and 85.0 or less,

a2 is −2.0 or more and 7.0 or less,

b2 is 4.0 or more and 28.0 or less,

L1>L2,

a1<a2, and

b1<b2,

where (L1, a1, b1) represent post-sinter (L*, a*, b*) of the L*a*b* color system at a first point falling within an interval from one end of the upper end portion to 15% of the entire length on a straight line extending along a first direction from one end of the upper end portion of the preform to the other end (one end of the lower end portion), and (L2, a2, b2) represent post-sinter (L*, a*, b*) of the L*a*b* color system at a second point falling within an interval from one end of the lower end portion to 15% of the entire length on a straight line extending along the first direction from one end of the upper end portion of the preform to the other end,

and that the post-sinter (L*, a*, b*) in the L*a*b* color system show unchanging patterns of increase and decrease from the first point to the second point.

Preferably, L1 is 69.0 or more and 89.0 or less, a1 is −2.7 or more and 4.0 or less, b1 is 1.0 or more and 23.5 or less, L2 is 61.5 or more and 84.5 or less, a2 is −1.5 or more and 6.5 or less, and b2 is 5.5 or more and 26.0 or less.

More preferably, L1 is 70.0 or more and 87.0 or less, a1 is −2.5 or more and 3.7 or less, b1 is 2.0 or more and 23.0 or less, L2 is 63.0 or more and 84.0 or less, a2 is −1.2 or more and 6.0 or less, and b2 is 7.0 or more and 24.0 or less.

By satisfying these ranges, the preform can match its color with the average shade of a natural tooth.

It is preferable in a preform of the present invention that L1−L2 be more than 0 and 12.0 or less, a2−a1 be more than 0 and 6.0 or less, and b2−b1 be more than 0 and 12.0 or less. More preferably, L1−L2 is more than 0 and 10.0 or less, a2−a1 is more than 0 and 5.5 or less, and b2−b1 is more than 0 and 11.0 or less. Even more preferably, L1−L2 is more than 0 and 8.0 or less, a2−a1 is more than 0 and 5.0 or less, and b2−b1 is more than 0 and 10.0 or less. Particularly preferably, L1−L2 is 1.0 or more and 7.0 or less, a2−a1 is 0.5 or more and 3.0 or less, and b2−b1 is 1.6 or more and 6.5 or less. Most preferably, L1−L2 is 1.5 or more and 6.4 or less, a2−a1 is 0.8 or more and 2.6 or less, and b2−b1 is 1.7 or more and 6.0 or less.

By satisfying these ranges, the preform can more desirably reproduce the shade of a natural tooth.

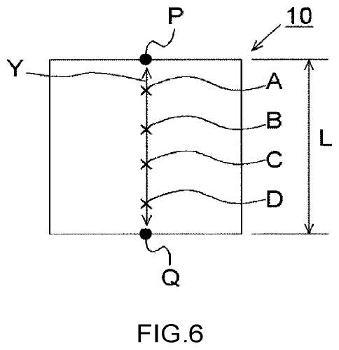

Preferably, a preform of the present invention shows a color change from one end to the other end of the preform. This is described below with reference to FIG. 6, which is a schematic view of a preform (preferably, a zirconia sintered body). FIG. 6 shows a zirconia sintered body 10 with a straight line extending along a first direction Y from one end P to the other end Q. Preferably, the pattern of increase or decrease of L*, a*, and b* values does not change in the opposite direction. Specifically, when the L* value is in a pattern of decrease on a straight line from one end P to the other end Q, it is preferable that there exist no interval in which the L* value essentially increases. For example, referring to FIG. 6 showing a first point A and a second point D on a straight line connecting one end P to the other end Q, it is preferable that there exist no interval in which the L* value increases by 1 or more, more preferably 0.5 or more when the L* value is in a pattern of decrease from first point A to second point D on a straight line connecting first point A and second point D. When the a* value is in a pattern of increase on a straight line from one end P to the other end Q, it is preferable that there exist no interval in which the a* value essentially decreases. For example, when the a* value is in a pattern of increase from first point A to second point D on a straight line connecting first point A and second point D, it is preferable that there exist no interval in which the a* value decreases by 1 or more, more preferably 0.5 or more. When the b* value is in a pattern of increase on a straight line from one end P to the other end Q, it is preferable that there exist no interval in which the b* value essentially decreases. For example, when the b* value is in a pattern of increase from first point A to second point D on a straight line connecting first point A and second point D, it is preferable that there exist no interval in which the b* value decreases by 1 or more, more preferably 0.5 or more.

Concerning the direction of color change of the preform (10) as a zirconia sintered body, it is preferable that the a* and b* values show a pattern of increase from one end P to the other end Q when the L* value is in a pattern of decrease in this direction. For example, the color changes from white to pale yellow, pale orange, or pale brown from one end P to the other end Q.

In the preform (10) of FIG. 6, a third point B lies between the first point A and the second point D on the straight line connecting one end P to the other end Q. When (L*, a*, b*) of the L*a*b* color system at the third point B is (L3, a3, b3), it is preferable that L3 be 66.0 or more and 89.0 or less, a3 be −2.5 or more and 6.0 or less, b3 be 1.5 or more and 25.0 or less, L1>L3>L2, a1<a3<a2, and b1<b3<b2.

A fourth point C lies between the third point B and the second point D. When (L*, a*, b*) of the L*a*b* color system at the fourth point is (L4, a4, b4), it is preferable that L4 be 62.0 or more and 86.0 or less, a4 be −2.2 or more and 7.0 or less, b4 be 3.5 or more and 27.0 or less, L1>L3>L4>L2, a1<a3<a4<a2, and b1<b3<b4<b2.

In the preform (10) of FIG. 6, it is preferable that the first point A lie in an interval from one end P (one end of the upper end portion) to 15% of the length (hereinafter, referred to as “entire length”) between one end P and the other end Q (one end of the lower end portion). Preferably, the third point B lies in an interval from a position away from one end P by 20% of the entire length to a position 80% of the entire length from one end P. For example, the third point B may be at a distance that is 35% of the entire length from one end P. Preferably, the second point D lies in an interval from the other end Q to 15% of the entire length. Preferably, the fourth point C lies in an interval from a position away from the other end Q by 20% of the entire length to a position 80% of the entire length from the other end Q. For example, the fourth point C may be at a distance that is 35% of the entire length from the other end Q (i.e., 65% of the entire length from one end P). A certain preferred embodiment is, for example, a machinable preform in which a first point A and a second point D, and, optionally, a third point B and a fourth point C are set at these positions, and the values of (L*, a*, b*) are adjusted. By setting these points at such positions, the preform, together with its structural characteristics, can have preferable aesthetic properties as a sintered ceramic preform (preferably, a sintered zirconia preform), without requiring further coloring. Such a machinable zirconia sintered body has a shade with gradually changing colors, and requires no further coloring or further sintering. Accordingly, the conventionally required step of sintering a machined unsintered body is not required, and a ceramic restoration can be fabricated at the dental office. The present invention greatly differs from related art in this respect.

An example of a method for producing a preform of the present invention is described below.

First, a method of production of a pre-sinter preform is described, taking as an example a zirconia preform made of zirconia. Zirconia and a stabilizer are pulverized and mixed wet in water to form a slurry. The slurry is dried to granulate into a granulated material. The granulated material is fired to produce a primary powder.

The primary powder is divided into the number of layers to be layered. For example, when making a raw material composition having a total of 4 layers, the primary powder is divided into 4 portions to prepare first to fourth powders. A pigment is added to each powder. The pigment is added in an amount that is appropriately adjusted to develop the color needed for each layer. The zirconia powder of each color is then mixed in water until the desired particle diameter is achieved. The resulting zirconia slurry is dried to granulate into a secondary powder corresponding to each layer. An additive may be added to the raw material composition, in addition to zirconia, the stabilizer, and the pigment. Examples of such additives include alumina, titanium oxide, and a binder. The additive may be used alone, or two or more thereof may be used in combination. When an additive is added to the raw material composition, the additive may be added when preparing the primary powder, or when preparing the secondary powder.

Examples of the pigment include a colorant, a complex pigment, and a fluorescent agent. The pigment may be used alone, or two or more thereof may be used in combination. Examples of colorants among the pigments include an oxide (for example, NiO, Cr₂O₃) of at least one element selected from the group consisting of Ti, V, Cr, Mn, Fe, Co, Ni, Zn, Y, Zr, Sn, Sb, Bi, Ce, Pr, Sm, Eu, Gd, Tb, and Er. Examples of the complex pigment include (Zr,V)O₂, Fe(Fe,Cr)₂O₄, (Ni,Co,Fe)(Fe,Cr)₂O₄—ZrSiO₄, and (Co,Zn)Al₂O₄. Examples of the fluorescent agent include Y₂SiO₅:Ce, Y₂SiO₅:Tb, (Y,Gd,Eu)BO₃, Y₂O₃:Eu, YAG:Ce, ZnGa₂O₄:Zn, and BaMgAl₁₀O₁₇:Eu.

The next step is to layer the powders one after another. Layering of an upper layer is preceded by leveling the top surface of a lower layer without pressing. For example, the powder of the lower layer is leveled off to provide a flat top surface. For preparation of a four-layer raw material composition, for example, a first powder is charged into a mold to a predetermined thickness (for example, 25 to 45% of the total thickness). Here, the top surface of the first powder is leveled without pressing. A second powder is then charged onto the first powder to a predetermined thickness (for example, 5 to 25% of the total thickness). The top surface of the second layer is leveled without pressing. Thereafter, a third powder is charged onto the second powder to a predetermined thickness (for example, 5 to 25% of the total thickness). The top surface of the third layer is leveled without pressing. A fourth powder is then charged onto the third powder to a predetermined thickness (for example, 25 to 45% of the total thickness). The top surface of the fourth layer is leveled without pressing. Preferably, the first to fourth layers are layered in increasing or decreasing order of pigment content. When preparing a raw material composition having a total of four layers, for example, the same stabilizer (preferably, yttria) content may be set for each layer within the foregoing ranges, in view of providing the same basic properties for each layer, and ensuring stable processing. In view of advantages such as obtaining a zirconia sintered body having even superior translucency and strength, the yttria content in the shaped preform after sintering is preferably about 2 mol % to about 8.5 mol %, more preferably about 2 mol % to about 7 mol %, even more preferably about 2.5 mol % to about 6.5 mol %, particularly preferably about 3 mol % to about 6 mol % relative to the total number of moles of zirconia and yttria. Yttria may be added to the raw material composition in such a manner that the yttria content in the shaped preform after sintering falls in these ranges. For example, in certain preferred embodiments, when using a four-layer raw material composition, substantially the same thickness may be set for all the layers, taking into account the influence of the preform shape. When a preform of the present invention has a multilayer structure, the shade may be set after setting substantially the same thickness for all the layers, in contrast to related art (for example, a block shape, a mill blank shape) in which the layers at the both ends are thick, and the intermediate layer is thin.

Because the previously charged layers are not pressed before charging the next layer, the adjacent layers can have improved adhesion in the sintered body, and the sintered body can have increased strength. The adjacent layers can also have a more subtle color difference. In this way, the sintered body can have a gradation with a natural transition of color from one layer to the next.

After laminating all layers, the layers are pressed into a molded product. Press forming may be performed, for example, at the pressures used in the Examples described below. Press forming may be performed by CIP. The molded body obtained is fired (i.e., pre-sintered) into a pre-sintered body at a temperature that does not sinter the zirconia particles. The pre-sintering temperature is not particularly limited, and is preferably 800° C. or more, more preferably 900° C. or more, even more preferably 950° C. or more. The firing temperature is not particularly limited, and is preferably 1,200° C. or less, more preferably 1,150° C. or less, even more preferably 1,100° C. or less.

The pre-sintered body obtained is milled with a known CAD/CAM system (for example, KATANA® CAD/CAM system; Kuraray Noritake Dental Inc.) based on predetermined structure data (for example, FIG. 1A, FIG. 2A) to obtain a pre-sinter shaped preform having a cylindrical preform body. A known molding process, including injection molding, may be used for fabrication, using the raw material composition, as described above.

A fully sintered zirconia preform can then be fabricated by firing the pre-sinter shaped preform at a temperature (sinterable temperature) that sinters the zirconia particles.

The present invention encompasses combinations of the foregoing features, provided that such combinations made in various forms within the technical idea of the present invention can produce the effects of the present invention.

### EXAMPLES

The following describes the present invention in greater detail by way of Examples. It should be noted that the present invention is in no way limited by the following Examples, and various changes may be made by a person with ordinary skill in the art within the technical idea of the present invention.

### Examples 1 to 5 and Comparative Examples 1 and 2

### Fabrication of Zirconia Pre-Sintered Body and Sintered Body

In Examples and Comparative Examples, zirconia pre-sintered bodies and sintered bodies thereof were fabricated using the following procedures.

The raw material powder used for fabrication of zirconia pre-sintered bodies was prepared as follows. First, a mixture having the yttria content shown in Table 1 was prepared using a zirconia powder and a yttria powder. The mixture was added to water to prepare a slurry, and pulverized and mixed wet with a ball mill until an average particle diameter of 0.13 μm or less was achieved. After pulverization, the slurry was dried with a spray dryer, and the resulting powder was fired at 950° C. for 2 hours to prepare a powder (primary powder). The average particle diameter can be determined by using a laser diffraction scattering method. Specifically, for example, the average particle diameter can be measured by volume using a laser diffraction scattering method, using a laser diffraction particle size distribution analyzer (SALD-2300, manufactured by Shimadzu Corporation) with a 0.2% sodium hexametaphosphate aqueous solution used as dispersion medium.

The primary powder was divided into four portions, first to fourth powders. Pigments were added to each powder in the compositions shown in Table 1. The numeric values shown in Table 1 represent pigment contents relative to a mixed powder of zirconia and yttria (100 mass %). After adding pigments, each powder was added to water to prepare a slurry, and pulverized and mixed wet with a ball mill until an average particle diameter of 0.13 μm or less was achieved. After pulverization, a binder was added to the slurry, and the slurry was dried with a spray dryer to prepare first to fourth powders (secondary powders).

A method of production of a zirconia pre-sintered body is described below. First, 35 g of the first powder of the secondary powder was charged into an 82 mm×25 mm die (inside dimensions), and the top surface of the first powder was leveled to provide a flat surface. On the first powder was charged 15 g of the second powder, and the top surface of the second powder was leveled to provide a flat surface. In a similar fashion, 15 g of the third powder was charged onto the second powder, and the top surface of the third powder was leveled to provide a flat surface. On the third powder was charged 35 g of the fourth powder, and the top surface of the fourth powder was leveled. Finally, with the upper die set on the powders, the powders were subjected to primary pressing at a surface pressure of 300 kg/cm² for 90 seconds, using a uniaxial pressing machine. The resulting primary press-molded body was then formed into a molded body of a four-layer structure by CIP at 1,700 kg/cm² for 5 minutes.

The molded body was fired at 1,000° C. for 2 hours to prepare a zirconia pre-sintered body. The zirconia pre-sintered body was then milled into a cylindrical pre-sinter shaped preform with a CAD/CAM system (KATANA® CAD/CAM system; Kuraray Noritake Dental Inc.). The intermediate pre-sinter shaped form (pre-sinter shaped preform) had a cylindrical body having an upper end portion and a lower end portion, a stem having a first stem-end equidistant from the upper end portion and the lower end portion, and extending orthogonally from the central portion with respect to the length of the cylindrical body, and an attaching member attached to a second stem-end, as substantially shown in FIG. 1A. The preform had a cavity extending inwardly from the lower end surface. The stem had a length long enough to position the tip of a ball grinding tool between the attaching member and the cylindrical body along the z axis without contacting the sintered preform. The attaching member had the shape and size suited to be attached to the mandrel used with a CNC machine in the grinding process.

The pre-sinter shaped form was fired at 1,500° C. for 2 hours to form a fully sintered zirconia preform having a density of about 5.9 g/cm³ to 6.1 g/cm³. The fully sintered zirconia preform (zirconia sintered body) had a body length of about 12.8 mm to 14.2 mm, a cross sectional outer diameter of about 14 mm to 15 mm, a cavity breakout diameter of about 7 mm to 8 mm at the lower end surface, a first stem-end width of about 2 to 2.8 mm, and a stem length of about 6.8 to 7.3 mm.

Confirmation of Shade of Zirconia Sintered Body (1)

The zirconia sintered body of each Example and Comparative Example was milled into a prosthesis for front teeth. After milling, the prosthesis for front teeth was visually inspected for comparative evaluation of shade against the appearance of a natural tooth (n=1). The results are presented in Table 1 under the column with “Visual inspection”. The zirconia sintered body was evaluated as “Good” when it formed a gradation, and had a shade similar in appearance to a natural tooth, and “Poor” when the zirconia sintered body did not form a gradation, or the shade did not have an appearance similar to a natural tooth.

In Examples 1 to 5, it was possible to obtain crown-shaped zirconia sintered bodies that formed a gradient from yellowish white to pale yellow with at most 60 minutes of processing from the zirconia preform, from a region corresponding to the first layer derived from the first powder to a region corresponding to the fourth layer derived from the fourth powder, and were similar in appearance to a natural tooth.

In contrast, the enamel portion and the body portion had the same shade in Comparative Example 1, whereas the sintered body had a strong shade of yellow in Comparative Example 2. In Comparative Examples 1 and 2, the shade was unnatural compared to a natural tooth, and it was not possible to say that the appearance was similar to a natural tooth.

Confirmation of Shade of Zirconia Sintered Body (2)

The zirconia sintered body of each Example and Comparative Example was quantitatively evaluated for its shade, as follows. The first to fourth powders (secondary powders) of each example were individually fabricated into zirconia sintered bodies, and were measured for (L*, a*, b*) in line with the L*a*b* color system (JIS Z 8781-4:2013, Color Measurements—Section 4: CIE 1976 L*a*b* color space). The (L*, a*, b*) of the individual zirconia sintered body fabricated from each powder correspond to the (L*, a*, b*) at each point of a zirconia sintered body fabricated from a laminate of the four powders. Specifically, the first powder, the second powder, the third powder, and the fourth powder correspond to a first point A, a third point B, a fourth point C, and a second point D, respectively. For the measurement of (L*, a*, b*), the individual zirconia sintered body produced from each powder was fabricated into a disc plate measuring 14 mm in diameter and 1.2 mm in thickness (both surfaces were polished, #600), and measured against a white background with a spectrophotometer CM-3610A, manufactured by Konica Minolta Inc. (D65 illuminant, measurement mode SCI, a diameter ratio of measurement area to illumination area=8 mm:11 mm) (n=1). The evaluation results are presented in Table 1.

Measurement of Vickers Hardness

Measurements were made in compliance with JIS Z 2244:2009, using the sintered bodies obtained in the Examples and Comparative Examples below. The Hv value was calculated with a retention time of 30 seconds under a load of 20 kgf, using the Falcon 500 manufactured by Innovatest (an average of n=5). The sintered body fabricated from the first powder of Example 3 had an Hv value of 1,351 (=13.2 Hv (GPa)). The sintered body fabricated from the fourth powder of Example 3 had an Hv value of 1,345. The sintered body fabricated from the first powder of Example 5 had an Hv value of 1,358 (=13.3 Hv (GPa)).

TABLE 1

| | | Yttria | | | | Shade evaluation of sintered body | | | | Processing |
|---|---|---|---|---|---|---|---|---|---|---|
| | | content | Pigment content (mass %) | | | | | | Visual | time |
| | | (mol %) | NiO | (Zr, V)O₂ | Cr₂O₃ | L* | a* | b* | inspection | (minutes) |
| Example 1 | First powder | 5.5 | 0.0093 | 0.0143 | 0 | 82.1 | −1.2 | 15.6 | Good | 48 |
| | Second powder | 5.5 | 0.012 | 0.0185 | 0 | 81.2 | −0.7 | 17.2 | | |
| | Third powder | 5.5 | 0.0144 | 0.0222 | 0 | 80.3 | −0.1 | 18.5 | | |
| | Fourth powder | 5.5 | 0.017 | 0.0245 | 0 | 79 | 1 | 20 | | |
| Example 2 | First powder | 5.5 | 0.015 | 0.04 | 0.001 | 79.3 | 0.6 | 23.5 | Good | 50 |
| | Second powder | 5.5 | 0.018 | 0.052 | 0.0014 | 78.7 | 1.6 | 24.2 | | |
| | Third powder | 5.5 | 0.021 | 0.064 | 0.0018 | 77.8 | 2.2 | 26.3 | | |
| | Fourth powder | 5.5 | 0.024 | 0.075 | 0.0022 | 77.4 | 2.8 | 27.4 | | |
| Example 3 | First powder | 5.5 | 0 | 0.001 | 0.0007 | 86.3 | −1.0 | 4.4 | Good | 51 |
| | Second powder | 5.5 | 0.0001 | 0.002 | 0.0015 | 85.2 | −0.7 | 6.6 | | |
| | Third powder | 5.5 | 0.0002 | 0.0036 | 0.002 | 84.5 | −0.5 | 7.8 | | |
| | Fourth powder | 5.5 | 0.0003 | 0.0052 | 0.0025 | 84.1 | −0.2 | 8.6 | | |
| Example 4 | First powder | 5.5 | 0.030 | 0.036 | 0.003 | 68.3 | 4.2 | 18.8 | Good | 47 |
| | Second powder | 5.5 | 0.035 | 0.050 | 0.004 | 65.5 | 4.9 | 19.2 | | |
| | Third powder | 5.5 | 0.047 | 0.065 | 0.005 | 63.8 | 6.1 | 19.8 | | |
| | Fourth powder | 5.5 | 0.052 | 0.072 | 0.006 | 61.9 | 6.8 | 20.5 | | |
| Example 5 | First powder | 6.0 | 0.006 | 0.011 | 0.002 | 79.0 | 0.1 | 14.0 | Good | 45 |
| | Second powder | 6.0 | 0.007 | 0.013 | 0.003 | 78.0 | 0.5 | 15.3 | | |
| | Third powder | 6.0 | 0.011 | 0.021 | 0.004 | 75.0 | 1.8 | 17.2 | | |
| | Fourth powder | 6.0 | 0.012 | 0.024 | 0.005 | 73.9 | 2.3 | 17.5 | | |
| Comparative | First powder | 5.5 | 0.0093 | 0.0143 | 0 | 82.1 | −1.2 | 15.6 | Poor | 52 |
| Example 1 | Second powder | 5.5 | 0.0093 | 0.0143 | 0 | 82.1 | −1.2 | 15.6 | | |
| | Third powder | 5.5 | 0.0093 | 0.0143 | 0 | 82.1 | −1.2 | 15.6 | | |
| | Fourth powder | 5.5 | 0.0093 | 0.0143 | 0 | 82.1 | −1.2 | 15.6 | | |
| Comparative | First powder | 5.5 | 0.047 | 0.072 | 0.001 | 65 | 6.5 | 20.2 | Poor | 50 |
| Example 2 | Second powder | 5.5 | 0.052 | 0.08 | 0.001 | 63.2 | 7 | 20.9 | | |
| | Third powder | 5.5 | 0.065 | 0.09 | 0.002 | 61.4 | 7.8 | 21.8 | | |
| | Fourth powder | 5.5 | 0.078 | 0.1 | 0.002 | 59.5 | 7.9 | 22.1 | | |

These results confirmed that the machinable preforms for shaping into dental restorations of the present invention have aesthetic properties suited for dental use (particularly, front teeth), without requiring coloring or firing after shaping.

### INDUSTRIAL APPLICABILITY

A machinable preform for shaping into dental restorations of the present invention can be used for dental products such as prostheses.

### REFERENCE SIGNS LIST

10, 100, 200, 300, 500: Preform
101, 201, 301, 501: Preform body
102, 202, 302, 402, 502: Stem
103: Dental restoration design
104, 204, 304, 504: Outer surface
105, 506: Lower end region
106: First filleted edge
107: Lower end surface
108: Second filleted edge
109, 311, 512: Depression
110, 208, 308, 513: Cavity
111, 205, 306, 505: Central portion
112: Cross-sectional geometric shape
113, 507: Upper end region
114: Inscribed circle
115: Circumscribed circle
206: Upper end portion
207: Lower end portion
303, 503: Attaching member
305: Mandrel
313: First stem-end
314: Second stem-end
400: Final dental restoration
401: Dental crown restoration
508, 508′: Chamfered edge
509: Lower end surface
510: Upper end surface
A: First point
B: Third point
C: Fourth point
D: Second point
P: One end
Q: Other end
L: Entire length
Y: First direction

1. A machinable preform for shaping into a dental restortion, comprising:
a body constituted of a machinable dental material having a Vickers hardness of 4 to 20 HV (GPa), and that comprises an outer surface, an upper end portion, a lower end portion, and a central portion between the upper end portion and the lower end portion;
a stem having a first stem-end and a second stem-end, the first stem-end having a width of 4 mm or less, and the stem being connected to the body at the first stem-end; and
an optional attaching member connected to the stem at the second stem-end and with which the sintered ceramic preform is attached to a shaping machine while shaping,
the central portion of the body, at a position of the first stem-end, having a cross-sectional geometric shape with an inscribed circle having a diameter of more than 12 mm, and a circumscribed circle having a diameter of less than 20 mm,
the preform showing a color change in a first direction from the upper end portion to the lower end portion,
the preform showing unchanging patterns of increase and decrease of post-sinter (L*, a*, b*) in the L*a*b* color system from the upper end portion to the lower end portion.

2. The machinable preform for shaping into a dental restortion according to claim 1, wherein the central portion comprises a cylindrical body, and a circular cross-sectional geometric shape having a diameter of less than 20 mm at the position of the first stem-end.

3. The machinable preform for shaping into a dental restortion according to claim 1, wherein the body of the preform further comprises a cavity extending toward the central portion from the lower end surface, and included in the outer surface of the preform body.

4. The machinable preform of claim 1, wherein the machinable dental material comprises a sintered zirconia ceramic material representing zirconia with at least 85 mass % fully sintered zirconia, or representing fully sintered yttria-stabilized zirconia.

5. The machinable preform of claim 1, wherein:
L1 is 68.0 or more and 90.0 or less,
a1 is −3.0 or more and 4.5 or less,
b1 is 0.0 or more and 24.0 or less,
L2 is 60.0 or more and 85.0 or less,
a2 is −2.0 or more and 7.0 or less,
b2 is 4.0 or more and 28.0 or less,
L1>L2,
a1<a2, and
b1<b2,
where (L1, a1, b1) represent post-sinter (L*, a*, b*) of the L*a*b* color system at a first point falling within an interval from one end of the upper end portion to 15% of the entire length on a straight line extending along a first direction from one end of the upper end portion to one end of the lower end portion, and (L2, a2, b2) represent post-sinter (L*, a*, b*) of the L*a*b* color system at a second point falling within an interval from one end of the lower end portion to 15% of the entire length on a straight line extending along the first direction from one end of the upper end portion to one end of the lower end portion.

6. The machinable preform of claim 1, wherein:
L1−L2 is more than 0 and 12.0 or less,
a2−a1 is more than 0 and 6.0 or less, and
b2−b1 is more than 0 and 12.0 or less.

7. The machinable preform of claim 5, wherein:
when an L* value is in a pattern of decrease from the first point to the second point, there exists no interval in which the L* value after sintering increases by 1 or more from the first point to the second point on a straight line connecting the first point and the second point,
when an a* value is in a pattern of increase from the first point to the second point, there exists no interval in which the a* value after sintering decreases by 1 or more from the first point to the second point on a straight line connecting the first point and the second point, and
when a b* value is in a pattern of increase from the first point to the second point, there exists no interval in which the b* value after sintering decreases by 1 or more from the first point to the second point on a straight line connecting the first point and the second point.

8. The machinable preform of claim 5, wherein:
L3 is 66.0 or more and 89.0 or less,
a3 is −2.5 or more and 6.0 or less,
b3 is 1.5 or more and 25.0 or less,
L1>L3>L2,
a1<a3<a2, and
b1<b3<b2,
where (L3, a3, b3) represent post-sinter (L*, a*, b*) of the L*a*b* color system at a third point between the first point and the second point on a straight line connecting the first point to the second point.

9. The machinable preform of claim 5, wherein:
L4 is 62.0 or more and 86.0 or less,
a4 is −2.2 or more and 7.0 or less,
b4 is 3.5 or more and 27.0 or less,
L1>L3>L4>L2,
a1<a3<a4<a2, and
b1<b3<b4<b2,
where (L4, a4, b4) represent post-sinter (L*, a*, b*) of the L*a*b* color system at a fourth point between the third point and the second point on a straight line connecting the first point to the second point.

10. The machinable preform of claim 8, wherein:
the third point is at a distance that is 35% of the entire length from one end of the upper end portion, and
the fourth point is at a distance that is 65% of the entire length from one end of the upper end portion.
